(19) United States
(12) Patent Application Publication
(10) Pub. No.: US 2019/0259081 A1
(43) Pub. Date: Aug. 22, 2019

(54) Product Identification System

(71) Applicant: Jaylyn A. Hamm, Conroe, TX (US)

(72) Inventor: Jaylyn A. Hamm, Conroe, TX (US)

(21) Appl. No.: 16/283,511

(22) Filed: Feb. 22, 2019

Related U.S. Application Data
(60) Provisional application No. 62/634,001, filed on Feb. 22, 2018.

(51) Int. Cl. G06Q 30/06

(52) U.S. Cl. CPC G06Q 30/0627; G06Q 30/0641

(57) ABSTRACT

A system and method for identifying one or more products in an establishment meeting specific criteria. The system may comprise at least one criterion, a device, an analysis control unit, and a product notification system. The system may single out each product using the product notification system based on the at least one criterion provided by a user. The method may comprise providing at least one criterion, wherein the at least one criterion is provided by the user, inputting the at least one criterion into a device, analyzing the at least one criterion using an analysis control unit, and notifying the user with a product notification system.

### CROSS-REFERENCE TO RELATED MATERIAL

This application claims priority to U.S. Provisional Patent Application No. 62/634,001, filed on Feb. 22, 2018, titled “Product Identification System,” the entire disclosure of which is herein incorporated by reference.

### BACKGROUND

### Field of Invention

This invention relates to the field of product identification and more specifically to a system and method for singling out a product or products of an establishment based on specific criteria.

### Background of Invention

In certain establishments that contain a large amount of inventory and/or various types of products, it can be difficult for people such as, without limitation, consumers, customers, clients, and/or authorized personnel, to identify and/or locate a desired product or products. With regard to the present disclosure, the term “consumer” will be used to describe a consumer, customer, client, and/or member of authorized personnel. Currently, a consumer, whether alone or with the aid of an employee of an establishment, is forced to manually search all inventory carried by the establishment in order to obtain a desired product. Often times, the consumer will have specific criteria that a product needs to fulfill before locating and acquiring the product. To ensure the criteria has been met and to properly located the product, the consumer might consult an employee of the establishment. In some situations, the employee may not have adequate knowledge regarding the desired product or its location. As a result, identifying and/or locating a desired product can be difficult and time consuming for both the consumer and the employee.

Consequently, there is a need for a product identification system to provide a faster and easier way for consumers to single out a product or products of an establishment based on specific criteria.

### BRIEF SUMMARY OF THE INVENTION

These and other needs in the art are addressed in an embodiment by a system for singling out a product or product meeting specific criteria, the system comprising: criteria, a device, an analysis control unit, and a product notification system.

These and other needs in the art are addressed in an embodiment by a method for singling out a product or product meeting specific criteria, the method comprising: providing criteria, wherein the criteria are provided by a user, inputting the criteria into a device, analyzing the criteria using an analysis control unit, and notifying the user with a product notification system.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

These drawings illustrate certain aspects of some of the embodiments of the present invention and should not be used to limit or define the invention.

FIG. 1 illustrates a system for identifying a product or products meeting specific criteria.

### DETAILED DESCRIPTION OF THE INVENTION

The present invention relates generally to products sold in an establishment for residential, commercial, and industrial use. More particularly, embodiments relate to a system capable of identifying one or more products matching consumer-specific criteria. As the system is automated, all pricing may be stored on a handheld device and/or computer. This may prevent competitors from price shopping by going into the establishment and reviewing pricing. Additionally, the system may help employees of an establishment determine all available products that a consumer may be able to purchase based on criteria provided by the consumer. Furthermore, the system may also improve efficiency of matching a consumer who seeks a product having specific criteria with actual products that match said criteria.

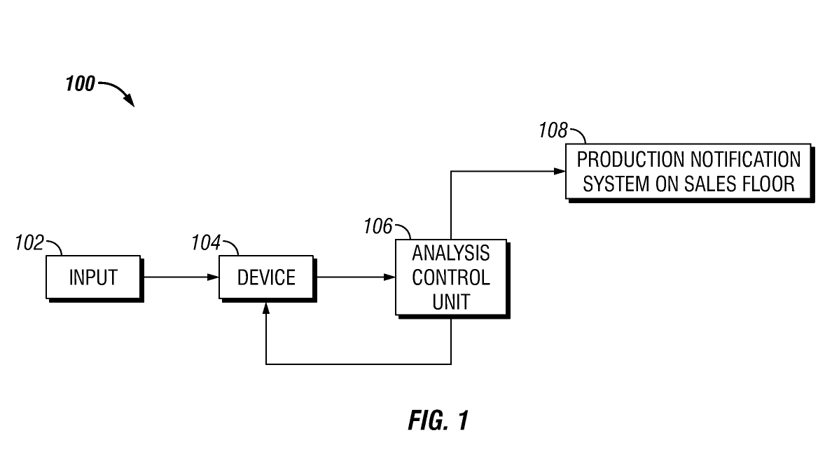

FIG. 1 is an example of identification system 100. Identification system 100 may be implemented in any establishment that provides goods in retail for residential, commercial, and/or industrial use. In an example, a consumer may visit a retail establishment to determine what product may be used for an identified project. The consumer may approach an employee for help and/or access a device 104, such as a computer or handheld device, which may have access to the products offered by the establishment. Speaking with an employee, the consumer may identify certain criteria 102 the consumer may be using in order to identify products that may be used for the identified project. Without limitation, criteria 102 may be any information capable of identifying and or distinguishing a product or service from other products or services offered in a given establishment. In a non-limiting example, the specified criteria may include, color, height, length, width, weight, product brand, style, shape, price, quality, inside or outside use, industrial use, commercial use, domestic use, which room is it for (e.g. a bathroom, a kitchen, etc.), what type of product is it (e.g. clothing, hardware for the home, electronics, food, beauty, etc.), durability, power source required, reviews and ratings, material, the like, and/or any combinations thereof. Criteria 102 may be input into device 104 by the employee. It should be noted that the consumer may enter the criteria 102 independently and without an employee's help into device 104.

Device 104 may translate the inputted criteria into computer readable code. Optionally, device 104 may transmit criteria 102 to analysis control unit 106. Analysis control unit 106 may then translate the transmitted information into a computer readable code. In a non-limiting example, analysis control unit 106 may further comprise a database (not shown). Database may comprise a list of all of the available products in a given establishment. Any suitable database may be used. Optionally, the computer readable code containing specified criteria 102 may be compared to the database list of products. Products containing the same computer readable code as specified criteria 102 may be marked and/or pulled and placed onto a second list. Analysis control unit 106 may then read and transmit signals containing the product information of all of the products from the second list to a product notification system 108. Product notification system 108 may be located at any suitable location within a given establishment.

In an embodiment, device 104 may be any device capable of transmitting and receiving signals and information, to and from analysis control unit 106. In a non-limiting example, device 104 may be a computer, a network storage device, a mobile device, a tablet, an iPad, the like, and/or any combinations thereof.

In an example, an analysis control unit 106 may control the operation of the merchandise selector assembly. Without limitation, the analysis control unit 106 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the analysis control unit 106 may be a computer, a network storage device, a mobile device, a tablet, an iPad, or any other suitable device and may vary in size, shape, performance, functionality, and price. In embodiments, the analysis control unit 106 may be a laptop. Analysis control unit 106 may include random access memory (RAM), one or more processing resources such as a central processing unit (CPU) or hardware or software control logic, ROM, and/or other types of nonvolatile memory. Additional components of analysis control unit 106 (not shown) may include one or more disk drives, one or more network ports for communication with external devices as well as various input and output (I/O) devices, such as a keyboard, a mouse, and a video display. The analysis control unit 106 may also include one or more buses operable to transmit communications between the various hardware components.

Certain examples of the present disclosure may be implemented at least in part with non-transitory computer-readable media. For the purposes of this disclosure, non-transitory computer-readable media may include any instrumentality or aggregation of instrumentalities that may retain data and/or instructions for a period of time. Non-transitory computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing. The foregoing figures and discussion are not intended to include all features of the present techniques to accommodate a buyer or seller, or to describe the system, nor is such figures and discussion limiting but exemplary and in the spirit of the present techniques.

Product notification system 108 may comprise any notification system capable of singling out a product or products fitting specified criteria. This may direct an employee and/or the consumer to products that match the consumer's criteria. In a non-limiting example, product notification system 108 may comprise a network of lights (not shown). The network of lights may be configured in any suitable manner capable of displaying and/or singling out a product or products matching specific criteria from the rest of the products offered. The network of lights may be connected in any suitable manner. The network of lights may be powered by any suitable power source. A suitable power source may include, a wired connection, solar power, a battery, the like, and/or any combination thereof. In an example, the network of lights may be programmed so that more than one customer may be matched with products matching specific criteria. In a non-limiting example, there may be more than one device 104 capable of transmitting information to analysis control unit 106. Each device 104 may be paired with a specific signal. Each signal, when transmitted to product notification system 108 may be programmed to display the products on the second list differently from other devices 104. In an example, the devices may be paired with different colors. When products from a given device 104 are identified, said products may be light up one color while a different device 104 may do the same thing but light up said products with a different color. Optionally, each device 104 may be paired with a unique light pattern. Any suitable light pattern may be used.

In an embodiment, the lights may line the shelf with which the product is displayed. Optionally, the light and or lights may be located above each individual product located within the store. Also, the light and or lights may be located on each individual product located within the store. The light and or lights may be located in any suitable location capable of illuminating a given product or products. Any suitable light source may be used. Suitable light sources may include, but are not limited to, a light bulb, a plurality of light bulbs, a light strip, a light emitting diode, the like, and or any combination thereof. The light source or sources may be connected in any suitable fashion. Additionally, light source or sources may be powered by any suitable power source.

In another non-limiting example, products meeting specific criteria identified by analysis control unit 106 may be transmitted back to device 104. Device 104 may then take that information and create a virtual map of the establishment. In an example, virtual map may display the location and or highlight products offered by the establishment that meet the specified criteria. Device 104 may produce any suitable virtual map. In an embodiment, any technique or method for highlighting, displaying, or singling out a product or products may be used.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A system for identifying one or more products meeting specific criteria, the system comprising:
at least one criterion;
a device;
an analysis control unit; and
a product notification system.

2. The system of claim 1, wherein the at least one criterion comprises color, height, length, width, weight, product brand, style, shape, price, quality, inside or outside use, industrial use, commercial use, domestic use, which room is it for (e.g. a bathroom, a kitchen, etc.), what type of product is it (e.g. clothing, hardware for the home, electronics, food, beauty, etc.), durability, power source required, reviews and ratings, material, the like, or any combinations thereof.

3. The system of claim 1, wherein a user inputs the at least one criterion into the device.

4. The system of claim 1, wherein the device transmits and receives signals and information to and from the analysis control unit.

5. The system of claim 1, wherein the analysis control unit transmits and receives information to and from the device.

6. The system of claim 1, wherein the analysis control unit comprises a database, wherein the database comprises all products available at an establishment.

7. The system of claim 6, wherein the analysis control unit generates a list from the database based on the at least one criterion, wherein the list comprises one or more products.

8. The system of claim 1, wherein the analysis control unit transmits information to the product notification system.

9. The system of claim 7, wherein the product notification system singles out each product from the list using a network of lights.

10. The system of claim 7, wherein the device creates a virtual map displaying the location within the establishment of each product from the list.

11. A method for identifying one or more products meeting specific criteria, the method comprising:
providing at least one criterion, wherein the at least one criterion is provided by a user;
inputting the at least one criterion into a device;
analyzing the at least one criterion using an analysis control unit; and
notifying the user with a product notification system.

12. The method of claim 11, wherein the at least one criterion comprises color, height, length, width, weight, product brand, style, shape, price, quality, inside or outside use, industrial use, commercial use, domestic use, which room is it for (e.g. a bathroom, a kitchen, etc.), what type of product is it (e.g. clothing, hardware for the home, electronics, food, beauty, etc.), durability, power source required, reviews and ratings, material, the like, and/or any combinations thereof.

13. The method of claim 11, wherein the user inputs the at least one criterion into the device.

14. The method of claim 11, wherein the device transmits and receives signals and information to and from the analysis control unit.

15. The method of claim 11, wherein the analysis control unit transmits and receives information to and from the device.

16. The method of claim 11, wherein the analysis control unit comprises a database, wherein the database comprises all products available at an establishment.

17. The method of claim 16, wherein the analysis control unit generates a list from the database based on the at least one criterion, wherein the list comprises one or more products.

18. The method of claim 11, wherein the analysis control unit transmits information to the product notification system.

19. The method of claim 17, wherein the product notification system singles out each product from the list using a network of lights.

20. The method of claim 17, wherein the device creates a virtual map displaying the location within the establishment of each product from the list.
